(19) United States
(12) Patent Application Publication
(10) Pub. No.: US 2006/0260881 A1
(43) Pub. Date: Nov. 23, 2006

(54) Brake pad having wear indication capability

(76) Inventors: Chris William Henley, Fenton, MI (US); Eric J. Roszman, Farmington Hills, MI (US); Takahashi Higurashi, Farmington Hills, MI (US)

Correspondence Address: CLARK & BRODY, 1090 VERMONT AVENUE, NW, SUITE 250, WASHINGTON, DC, 20005, US

(21) Appl. No.: 11/133,309

(22) Filed: May 20, 2005

(51) Int. Cl. F16D 66/02

(52) U.S. Cl. 188/1.11 W

(57) ABSTRACT

A brake pad with an integral wear indicator feature comprises a brake support plate, an underlayment on a surface of the brake support plate, and at least one friction material layer on the underlayment, the underlayment including an effective amount of metallic particles that have a cross sectional area of at least 0.05 mm², and a length greater than 0.10 mm. The underlayment produce a loudness of at least 70 dB and a frequency as measured six feet from the underlayment of at least 1.5 kHz when the underlayment contacts a braking surface of a brake assembly, thus providing a distinctive warning to a driver that brake service is required.

### TECHNICAL FIELD

The present invention is directed to a brake pad, and in particular to disk brake pad having the capability to indicate brake wear through generation of loud and high frequency noises.

### BACKGROUND ART

In the prior art, various techniques have been proposed to provide brake wear warnings to drivers of vehicles. Some techniques use mechanical indicators such as a reed that is bonded to the brake support plate and extends toward the brake rotor. When the brake pad friction material erodes to a certain degree, the reed contacts the rotor and produces an audible signal. These types of indicators can be problematic since the rotors can be damaged as a result of the contact by the indicator, or the indicator can break, thus eliminating the warning about brake wear.

Other approaches employ integral wear indicators that avoid contact with the rotors. In these types of indicators, modifications are made to the brake pad materials to generate an audible wear signal. U.S. Pat. No. 4,049,084 to Beemer et al. teaches one type of integral wear indicator that combines a primary frictional material with a secondary brake frictional material. Upon erosion of the primary frictional material, the secondary frictional material contacts a brake disc, the contact producing an audible sound. The secondary frictional material is preferably a material having a high static coefficient and a low dynamic coefficient to generate the audible sound. The problem with this technique is that bonding is required to form the frictional material from the two different types of materials. Because of the size and operating environment of this braking system, it is believed that it produces a lower frequency noise or groan. These types of noises generally produce low levels of sound pressure, i.e., low decibels, and may not meet a customer's requirements for brake wear indication, e.g., >70 dB at six (6) feet from a braking wheel.

U.S. Pat. No. 6,041,893 to Ervens et al. teaches another integral brake wear indicator. This indicator employs an intermediate layer arranged between a friction lining and a friction support material. The intermediate layer consists of a material mixture that is adapted to damp friction squealing and generate an acoustic alarm signal when reaching the wear limit. Dampening of squealing is achieved by adding an elastomeric material to the intermediate layer. Since elastomeric materials by nature have high levels of compressibility, they contribute poorly to the brake performance since additional piston retraction is required to prevent drag. While Ervens et al. teach that a low frequency noise is generated by the intermediate layer, and can be heard even in well-insulated cars, these low frequencies noises are still inherently difficult to hear by a driver.

Accordingly, a need exists for improved integral brake wear indicators, and methods of manufacture. The present invention responds to this need by providing a brake pad with integral wear indicator capability that produces a high frequency noise that is easily heard by drivers. Moreover, the integral wear indicator-containing brake pad of the invention is easier to make than the brake pads employing the integral wear indicators as taught by the prior art.

### SUMMARY OF THE INVENTION

It is a first object of the present invention to provide a brake pad with improved integral brake wear indicator capability.

Another object of the present invention is a method of making a brake pad with improved integral brake wear indicator capability.

Other objects and advantages will be come apparent as a description of the invention proceeds.

The invention is an improvement in the art of brake pads and their manufacture, and particularly brake pads that provide integral wear indication. The method aspect of the invention comprises applying an underlayment to a surface of a brake support plate. A layer of friction material is applied to an exposed surface of the underlayment, and the underlayment and friction layer are bonded to the brake support surface. The underlayment further comprises an effective amount of metallic particles, each having a cross sectional area of at least 0.05 mm², and a length greater than 0.10 mm. The metallic particles when included as part of the underlayment produce a loudness of at least 70 dB and a frequency of at least 1.5 kHz as measured six feet from the underlayment when the underlayment contacts a braking surface of a brake assembly.

The metallic particles can be added to the underlayment prior to the underlayment's application to the support surface of the brake plate, or can be added after this step. The metallic particles can be either ferrous or non-ferrous, and can be made of a metal containing iron, copper, nickel, zinc, cobalt, titanium or mixtures thereof. The metallic particles can have a cross sectional area that is generally round, polygonal or irregular, or can be a mixture of different shapes. Preferably, strands or fibers having a circular cross section are employed. Preferred amounts can range from 1 to up to 50% of the weight of the underlayment. In another mode, it is preferred that the underlayment is an elastomeric-free material so that the squealing tendencies of the underlayment are not dampened. The method can also entail applying an adhesive to a surface of the brake support plate prior to the step of applying the underlayment.

Another aspect of the invention entails a brake pad for a brake assembly. The brake pad encompasses the combination of the brake support plate, the underlayment adjacent the brake support surface, and at least one friction material layer adjacent the underlayment. As noted above the underlayment contains the effective amount of the metallic particles, in the specified cross sectional area and length to produce a loudness of at least 70 dB and a frequency of at least 1.5 kHz as measured six feet from the underlayment when the underlayment contacts a braking surface of a brake assembly.

### BRIEF DESCRIPTION OF THE DRAWINGS

FIG. 1 is a schematic side view of one embodiment of the invention;

FIG. 2 is a graph relating noise levels and frequency during a braking test of friction materials;

FIG. 3 is a graph relating noise levels and frequency during the braking test of FIG. 2 at a later point in time; and

FIG. 4 is a graph relating underlayment noise levels and frequency during the braking test of FIG. 2 at a point in time following the measurement of FIG. 3.

### DETAILED DESCRIPTION OF THE PREFERRED EMBODIMENTS

The invention provides a significant improvement in the field of brakes that have features that provide an indication of brake wear. The invention modifies the prior art brake pad construction by including metallic particles in the underlayment layer of the brake. The presence of an effective amount of these particles in the underlayment layer results in the generation of a high frequency and loud noise when friction material of the brake wears away, and the underlayment layer comes into contact with a braking surface of the brake assembly. The nature of the frequency and noise makes it easy for a driver to hear the noise, and be alerted that the brakes need to be serviced.

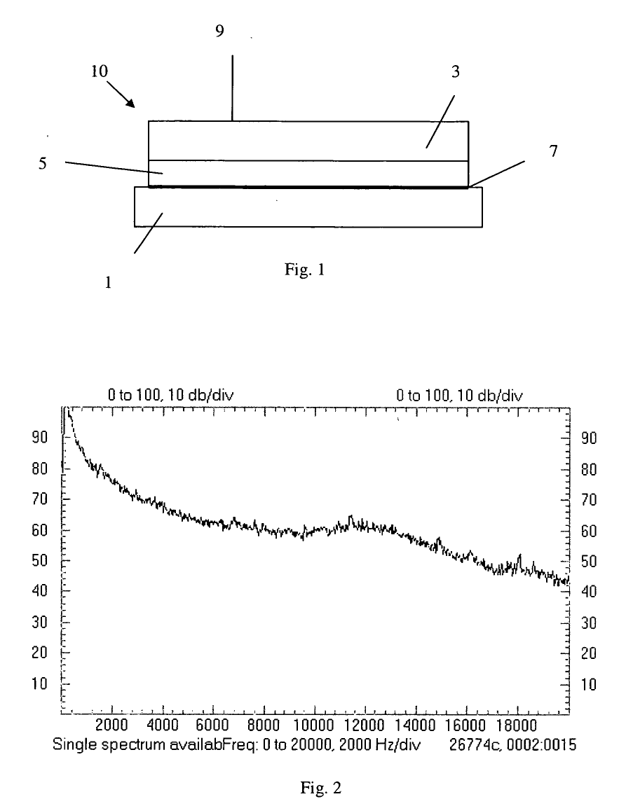

FIG. 1 of this application shows one example of the invention as a disk brake pad. The pad is generally designated by the reference numeral 10 and includes a brake support plate 1, an underlayment 3, and a friction material layer 5. If desired, an adhesive layer 7 can be disposed between the underlayment, and brake support surface, as is taught by United States Published Patent No. 2004/0206441 to Lamport, herein incorporated in its entirety by reference. The adhesive 7 can be any conventional type that is applied to the brake support plate to improve the bonding of the materials intended for use as part of the brake pad. Since the use of these types of adhesives is well known in the art, a further description of this aspect of the invention is not necessary for its understanding.

The thicknesses of the underlayment and the friction material layers can vary amongst different braking applications. An example of a thickness of the underlayment would be 2 mm with the friction material layer being about 10 mm.

The friction material layer 5 can be any type known in the art. Examples of such materials can be found in U.S. Pat. No. 6,193,025 to Nakagawa. Moreover, the layer 5 could comprise multiple friction material layers if so desired. One example of such a material is found in U.S. Pat. No. 3,967,037 to Marzocchi et al. Each of Nakagawa and Marzocchi et al. are herein incorporated by reference in their entirety.

The underlayment according to the invention is essentially a modified underlayment that comprises two main components. A first component is an underlayment matrix material that in one mode is made of a typical underlayment material as is used in the prior art. U.S. Pat. No. 6,382,027 to Uhlig, U.S. Pat. No. 5,888,645 to Lindgaard et al., and previously-noted U.S. Pat. No. 6,193,025 to Nakagawa describe the use of underlayments in brake construction, with Nakagawa exemplifying underlayment compositions, and the Uhlig and Lindgaard et al. patents are herein incorporated by reference in its entirety. As taught in Nakagawa, the prior art underlayment material is made to assist in the bonding of the friction material to the brake support plate, provide insulation between the friction material and the brake support plate, and reduce noises generated by friction material vibration. Another example of an underlayment composition includes the components shown in Table I:

TABLE I

| Material | Content (wt %) |
|---|---|
| Polymer | 0-12 |
| Ferrous Material | 29-62 |
| Non-Ferrous Material | 13-26 |
| Resins | 9-19 |
| Volume Enhancer | 22-37 |
| Abrasive | 1-6 |
| Composite Fiber | 0-12 |
| Stabilizer | 0-4 |

The volume enhancers include lime, fillers, and other known agents to increase volume in these types of materials. An example of an abrasive is silica. It is preferred that the first component does not include elastomers, i.e., is elastomeric-material free, since these materials act as dampening agents, and they would tend to dampen the desired high frequencies generated by the underlayment. It should also be understood that the metallic or non-metallic materials used in these materials are generally fairly small in size, e.g., up to 30-40 microns in size, which is far smaller than the metallic particles contemplated for use as part of the invention.

The second component of the underlayment comprises metallic particles, which can be either ferrous or non-ferrous particles. The particles are sized with a cross sectional area of greater than 0.05 mm², and a length greater than 0.10 mm. The particles can have virtually any shape, thus generating cross sectional areas of wide variety. For example, the particles can have cross sectional areas that are generally circular or oval, or polygonal, such as square, rectangular, triangular, or even irregular shapes that could combine straight and curved outer surfaces. Preferred cross sectional areas include circular, wherein the particles would take the form of fibers or strands. When selecting fibers as the shape of the particle, preferred sizes include diameters ranging from 0.1 to 2.0 mm, with more preferred ranges being between 0.30 and 1.60 mm. Preferred lengths range from 0.250 mm to 120 mm with a more preferred range of 1.0 mm to 60 mm, and an even more preferred range of between around 20 to 55 mm. If the particles are not of the required cross sectional area and length, it is believe that they will not produce or cause the rubbing excitation that leads to generation of the requisite loudness and high frequencies for wear indication. While it is believed to be no downside as the particles increase in size, if the particles are too large, they may interfere with the bonding of the materials. On the other hand, larger particles may be acceptable if they contribute to the integrity of the underlayment material or its bonding to the support plate and/or friction material. For example, the metallic material used could interact with the underlayment material in such a fashion that it would act as a strengthener as well as a wear indicator.

The metallic particles are used in an effective amount such that, when incorporated with the underlayment matrix material and made into a brake pad, a noise is generated that has a frequency of at least 1.5 kHz, preferably between 2 and 16 kHz, more preferably between 4 and 13 kHz, and most preferably between 4 and 6 kHz, and a loudness of at least 70 dB as measured six feet from the underlayment when the underlayment contacts a brake surface of a brake assembly. This distance is representative of the distance from the wheel to the driver's seat.

While the effective amount of the metallic particles used as part of the underlayment may vary in order to obtain the desired loudness and noise, a preferred amount ranges between about 1 and 50% by weight of the total underlayment weight, with a more preferred range being between about 3 and 25%, and an even more preferred weight range being between 5 and 17% by weight.

In an alternative mode, the underlayment matrix material could be modified to account for an increase in the metal percentage as a result of the addition of the metallic particles. For example, if the underlayment material contains a certain percentage of non-ferrous material, e.g., copper or copper-containing metallic particles are employed for noise generation, the underlayment matrix material could be adjusted by reducing the amount of copper in it so that the total copper amount of the underlayment now containing the wear indication copper particles is similar to the total amount of copper that was targeted for the original underlayment. The same adjustment could be made if iron particles were used for noise generation. For example, if the underlayment had a target content of copper of 40% by weight, and 10% copper is added as a result of the metallic particle addition, the underlayment matrix material could be adjusted to 30% copper to maintain an overall copper content of 40%.

Preferred metals that can be used to make up the metallic particles include iron, nickel, copper, zinc, cobalt, titanium, and the like. The metallic particles can be in elemental form, or the particles can be made as alloys, or composite structures such as coated or plated metals or alloys. For example, the particles could be a cast iron, a steel, a nickel or cobalt alloy, brass, a stainless steel, or combinations or mixtures thereof.

Referring again to the FIG. 1, the illustrated brake pad can be made using conventional braking manufacturing techniques. Typically, the underlayment layer is applied to the brake support plate, which may or may not employ a layer of adhesive on the surface intended to receive the underlayment material. The friction material is then applied onto the underlayment material, and a bonding process is followed to form the brake pad. Generally, a mold is used to shape the underlayment and friction material, and hot pressing or the like is used to bond the materials together, and to the brake support plate. Generally, the underlayment has a consistency that allows it to be easily applied onto the brake support plate and within the mold defining its shape. While a molding and hot pressing operation is described to form the composite structure of the friction material and underlayment on the brake support plate, any known bonding process can be employed to make the brake pad or other type of braking member employing the underlayment as described above. Thus, a further description of the details of the molding/bonding operation are not needed for understanding of the invention.

The method of making the brake pad that has wear indication capability is much simpler than prior art techniques, and thus provides a significant advantage in terms of manufacturing costs. The need for providing a mechanical modification to the brake support plate is eliminated. Also, since it is only the underlayment layer that requires modification, there are no additional bonding or applying steps required in the overall manufacturing process. The underlayment only needs to be modified by the addition of the effective amount of the metallic particles, and then the underlayment is applied and bonded with the other components of the brake pad as normally done. This modification can be done by either applying the underlayment material to the surface of a brake support plate as is commonly done, and then adding the metallic particles in the desired quantity to the applied underlayment. Alternatively, the underlayment and metallic particles could be first mixed together, and then applied to the brake support surface, followed by the remaining steps to form the completed brake pad. It should be understood that when premixing the metallic particles and underlayment for making a number of brake pads, the metallic particles should be distributed throughout the underlayment so that when the underlayment is applied, it has the necessary amount of the metallic particles for high frequency noise generation.

Referring again to the FIG. 1, in normal brake operation, the surface 9 of the friction material layer 5 contacts a surface of a brake component, e.g., a rotor surface, in a brake assembly. After a period of braking, the friction material layer 5 will erode, and eventually, the underlayment 3 will begin to contact the brake surface and a high pitched squeal will be produced as a result of the presence of the metallic particles in the matrix of underlayment material. The noise is believed to be generated either by rubbing excitation of the particles themselves to generate the high pitched frequency and loudness, and/or excitation of the matrix surrounding the particles, and/or excitation of the brake support plate, and/or excitation of the braking surface. Because of the loudness, i.e., >70 dB and frequency, greater than 1.5 kHz, or between 2 and 16 kHz, a driver of the vehicle containing the brake assembly will easily hear the squeal, and be alerted that brake pad replacement is required.

While it is preferred to use the combination of the friction material layer and underlayment in a brake pad application for a disk brake assembly, the combination could be employed in virtually any application wherein a warning that erosion of a brake friction material has occurred is desired. For example, the combination of the friction material layer and underlayment could be used in brake shoes for drum brakes, or clutch pads in clutch mechanisms, or virtually anywhere that a braking medium is used that would require an indication of brake material wear. For purposes of this application, the term “brake pad” is intended to not only encompass brake pads for use in disk brake assemblies but any brake component using one or more friction layers, one or more underlayments, and a brake support plate.

In order to demonstrate the improved wear indication capabilities of the invention via the modification of the underlayment, a number of tests were performed wherein brake pads were placed in a vehicle to measure the generation of loudness and frequencies. In the testing, brake pads were manufactured using friction materials and underlayments. Specifically, the fibers were added into the underlayment matrix material after it was charged to the mold. The friction material was then applied, and the layered materials were bonded to form the finished disk brake pad. After manufacturing of the brake pads, most of the friction material was removed by grinding to permit burnishing of the pad and a relatively quick exposing of the underlayment for testing purposes. The modified brake pads were then installed on a 2002 Ford Explorer 2×4 Sport Trac, and the vehicle was operated on the road under braking over a number of miles, and noise and loudness measurements were monitored during the occurrence of the squealing. Since some friction material was left on the pad, the squeal was not generated until a number of miles were driven during testing. The loudness or sound pressure was measured from the driver's seat of the vehicle using a handheld (Rion SA-77) signal analyzer to determine the levels that would be heard by an actual driver.

A first series of tests were performed using copper wire strands or fibers. A second test was performed using brass strands. The test parameters and results are shown in Table 2 below.

TABLE II

| | | | | | | Miles | |
|---|---|---|---|---|---|---|---|
| Metallic | | | | | | driven/ | Sound |
| particle | Dia. | Area | Length | Wt. | | noisy | Pressure |
| material | mm | mm² | mm | %¹ | Freq. kHz | miles² | dB |
| copper | .355 | .098 | 25 | 15.4 | 2.3, 8.3, | 2422/1056 | 58-87 |
| | | | | | 10.2 | | |
| brass | 1.57 | 1.936 | 25 | 15.4 | 10.2, 12.6 | 2176/693 | 78-81 |

¹Wt. % based on the weight of the material in the underlayment.
²noisy miles occurred after friction material was eroded to expose the underlayment for contact with the brake rotor.

As can be seen from Table II, modifying the underlayment material by adding the strands of copper or brass results in a significant noise generation at high frequencies at the driver's seat. With this high frequency noise and sound pressure level, the driver would easily be able to determine that the brakes needed servicing.

To put the test results of Table II in comparison to the noise and frequencies generated with conventional friction and underlayment materials, FIGS. 2-4 are presented. These figures show the results of dynamometer testing of a brake pad. The underlayment used in the tests producing the results of FIGS. 2-4 is the same as that used in the testing associated with Table II. These figures relate the sound pressure in decibels (dB) to frequencies over the range of 0 to 20,000 kHz. Sound pressure was measured 12 inches from the wheel.

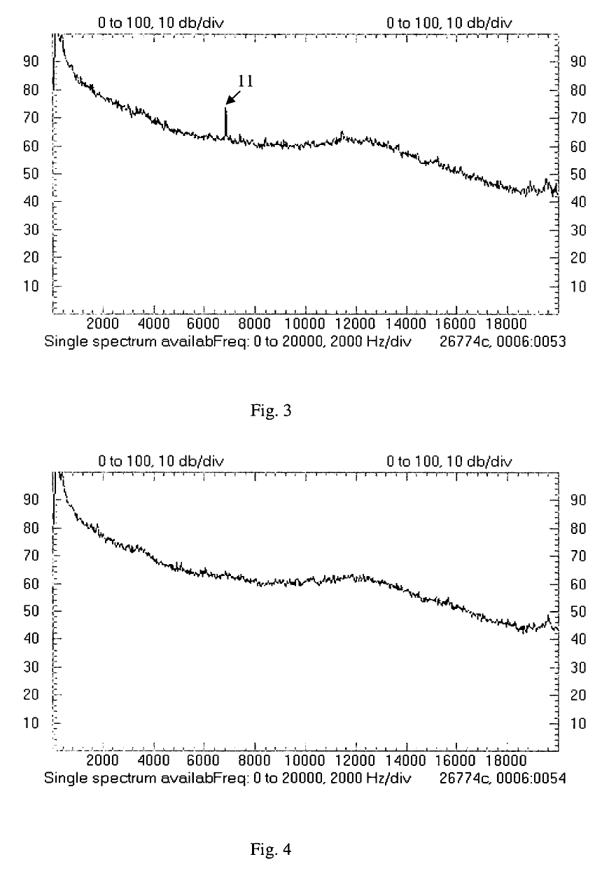

FIG. 2 shows the sound pressure generated by the friction material during braking at the start of the test. This test was a baseline stop test to burnish the friction material before the start of the wear indicator durability testing. FIG. 2 is also indicative of a quiet braking operation. FIG. 3 shows another point in time in the dynamometer test results, stop 53. The graph of FIG. 3 shows a spike 11 which represents the mechanical reed wear indicator contacting the rotor and generating a 6.8 kHz squeal at 72.6 dB. At this stop, the wear indicator also fractured, indicating that the wear indicator had a durability of 322 km.

When the test was continued without the wear indicator, the measurement recorded at the very next stop of the test is shown in FIG. 4. This test is indicative of the sound and frequency generated as a result of contact between the brake rotor and the underlayment. As is evident from FIG. 4, no squeal was produced. Further, overlaying the curve of FIG. 4 with that of FIGS. 2 and 3 reveals that the quiet braking condition of FIG. 2 occurs when the underlayment is in contact with the rotor during braking. This means that the underlayment material alone does not generate adequate squeal to alert a driver of the need for braking service. It also demonstrates that unexpectedly, the addition of the metallic particles to the underlayment material produces a loud and high frequency noise, which is ideal for alerting a driver that brake service is warranted.

It is also interesting to note that the squeal produced by the wear indicator was 72.6 dB as measured 12 inches from the wheel, see FIG. 3. In comparison and noting the results of Table II, the sound pressure generated by modifying the underlayment with the effective amount of particles showed similar sound pressures and frequency, but these levels were detected at the steering wheel, not just inches from the braking wheel. Thus, modifying the underlayment according to the invention generates more noise than the mechanical wear indicator.

As such, an invention has been disclosed in terms of preferred embodiments thereof which fulfills each and every one of the objects of the present invention as set forth above and provides a new and improved brake pad and method of making.

Of course, various changes, modifications and alterations from the teachings of the present invention may be contemplated by those skilled in the art without departing from the intended spirit and scope thereof. It is intended that the present invention only be limited by the terms of the appended claims.

We claim:

1. A method of making a brake pad with an integral wear indicator feature comprising:
a) applying an underlayment to a brake plate support surface;
b) applying a layer of friction material on an exposed surface of the underlayment;
c) bonding the underlayment and friction layer to the brake plate support surface;
d) wherein the underlayment further comprises an effective amount of metallic particles, each having a cross sectional area of at least 0.05 mm², and a length greater than 0.10 mm, the metallic particles producing a loudness of at least 70 dB and a frequency of at least 1.5 kHz as measured six feet from the underlayment when the underlayment contacts a braking surface of a brake assembly.

2. The method of claim 1, wherein the metallic particles are mixed into an underlayment matrix material prior to step (a) or are added to the underlayment matrix material after application of the underlayment matrix material to the brake plate support surface.

3. The method of claim 1, wherein the metallic fibers are made from a metal containing one or more of iron, copper, nickel, zinc, cobalt, titanium or mixtures thereof.

4. The method of claim 1, wherein the metallic particles have a cross sectional shape that is generally round, polygonal or irregular, or have a mixture of shapes that are round, polygonal or irregular.

5. The method of claim 1, wherein the underlayment is an elastomeric-free material.

6. The method of claim 1, wherein the metallic particles are about 1 to 50% by weight of the underlayment.

7. The method of claim 1, wherein the metallic particles are fibers.

8. The method of claim 1, wherein the metallic particles generate a frequency between 2 and 16 kHz.

9. The method of claim 1, further comprising applying an adhesive to a surface of the brake support plate prior to step (b).

10. A brake pad for a brake assembly, the brake pad having an integral wear indicator feature comprising:
a) a brake support plate;
b) an underlayment adjacent a surface of the brake support plate; and
c) at least one friction material layer adjacent the underlayment, wherein the underlayment further comprises an effective amount of metallic particles, each having a cross sectional area of at least 0.05 mm², and a length greater than 0.10 mm, the metallic particles producing a loudness of at least 70 dB and a frequency of at least 1.5 kHz as measured six feet from the underlayment when the underlayment contacts a braking surface of a brake assembly.

11. The brake pad of claim 10, wherein the metallic fibers are made of a metal containing one or more of iron, copper, nickel, zinc, cobalt, titanium or mixtures thereof.

12. The brake pad of claim 1, wherein the metallic particles have a cross sectional shape that is generally round, polygonal or irregular, or have a mixture of shapes that are round, polygonal or irregular.

13. The brake pad of claim 10, wherein the underlayment is an elastomeric-free material.

14. The brake pad of claim 10, wherein the metallic particles are about 1 to 50% by weight of the underlayment.

15. The brake pad of claim 10, wherein the metallic particles are fibers.

16. The brake pad of claim 10, wherein the metallic particles generate a frequency between 2 and 16 kHz.

17. The brake pad of claim 10, wherein the brake pad is one of a disk pad, a brake shoe or a clutch pad.

18. The brake pad of claim 10, further comprising an adhesive disposed between the brake support plate and the underlayment.
